(19) United States
(12) Patent Application Publication
(10) Pub. No.: US 2025/0004785 A1
(43) Pub. Date: Jan. 2, 2025

(54) BOOT PROGRAM SELECTION METHOD

(71) Applicant: STMicroelectronics International N.V., Geneva (CH)

(72) Inventor: Jawad BENHAMMADI, Pont de Claix (FR)

(21) Appl. No.: 18/742,726

(22) Filed: Jun. 13, 2024

(30) Foreign Application Priority Data
Jun. 30, 2023 (FR) 2306974

(51) Int. Cl. G06F 9/4401

(52) U.S. Cl. CPC G06F 9/4408

(57) ABSTRACT

The present description concerns a method of selection of boot programs, each contained in two separate storage memories of a microprocessor wherein an option register read first during a resetting of the microprocessor conditions the selection of one of the boot programs.

### CROSS REFERENCE TO RELATED APPLICATIONS

This application claims the priority benefit of French patent application number FR2306974, filed on Jun. 30, 2023, entitled “Procédé de Sélection de Programmes de Démarrage”, which is hereby incorporated by reference to the maximum extent allowable by law.

### TECHNICAL FIELD

The present disclosure generally concerns methods for selecting boot programs in microprocessors, as well as microprocessors implementing such methods.

### BACKGROUND

Many electronic circuits, such as microcontrollers, including systems on chip (SOC), comprise an architecture which enables to choose the security level of the resources and memories which are used by the applications implemented in these circuits.

However, certain architectures do not enable, basically, to choose between a plurality of security levels.

### BRIEF SUMMARY

There exists a need to provide methods for enabling to choose between a plurality of security levels in a circuit having an architecture which does not enable, basically to choose between a plurality of security levels.

An embodiment overcomes all or part of the disadvantages of known methods.

An embodiment provides for a method for selecting boot programs, each contained in two separate storage memories of a microprocessor wherein an option register read first during a resetting of said microprocessor conditions the selection of one of said boot programs.

In an embodiment, a first boot program is contained in a user memory and a second boot program is contained in a system memory.

In an embodiment, at the initialization of the system, when said option register has a first value, the first boot program is selected.

In an embodiment, at the initialization of the system, when said option register has another value, the second boot program is selected.

In an embodiment, the first boot program, when it is selected, is configured to modify a value of a second register representative of the size of a forbidden access region of the system memory containing the second boot program, so that said second boot program is not accessible.

In an embodiment, the first boot program, when it is selected, is configured to modify a value of the second register representative of the size of a forbidden access region of the system memory containing the second boot program and a third boot program, so that said second and third boot programs are not accessible.

In an embodiment, the value of the second register can only be incremented.

In an embodiment, the modification of said value of the second register is an increase by more than one bit.

In an embodiment, at least one application is executable from the user memory after the selection of the first boot program.

In an embodiment, the first boot program, when it is selected, implements a configuration of the microprocessor so that it is in a secure mode where, when a non-secure transaction requires access to a secure resource of the microprocessor, then an error is returned.

In an embodiment, the first boot program, when it is selected, implements a configuration of the microprocessor so that it is in a secure mode where, when a secure transaction requires access to a non-secure resource of the microprocessor, then an error is returned.

In an embodiment, the first boot program, when it is selected, enables to implement a debugging function authorized to access one or a plurality of regions of the memory corresponding to a value of the second register containing the second boot program and the third boot program.

In an embodiment, the user memory is a non-volatile memory or a RAM-type memory.

In an embodiment, a plurality of applications are executable from user memory after the use of the first boot program, and each of these applications is in a same secure mode.

An embodiment provides a microprocessor, comprising a system memory and a user memory, and configured to implement a method such as described above.

### BRIEF DESCRIPTION OF THE DRAWINGS

The foregoing features and advantages, as well as others, will be described in detail in the rest of the disclosure of specific embodiments given by way of illustration and not limitation with reference to the accompanying drawings, in which:

FIG. 1 very schematically shows in the form of blocks an example of an integrated circuit of the type to which the described embodiments apply;

FIG. 2 illustrates an implementation mode of a method of selecting boot programs for the circuit of FIG. 1; and

FIG. 3 illustrates another implementation mode of a method of selecting boot programs for the circuit of FIG. 1.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the steps and elements that are useful for the understanding of the described embodiments have been illustrated and described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, when reference is made to terms qualifying absolute positions, such as terms “edge”, “back”, “top”, “bottom”, “left”, “right”, etc., or relative positions, such as terms “above”, “under”, “upper”, “lower”, etc., or to terms qualifying directions, such as terms “horizontal”, “vertical”, etc., it is referred, unless specified otherwise, to the orientation of the drawings.

Unless specified otherwise, the expressions “about”, “approximately”, “substantially”, and “in the order of” signify plus or minus 10%, preferably of plus or minus 5%.

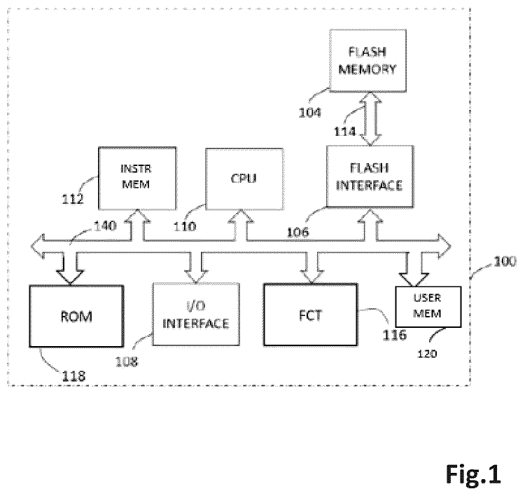

FIG. 1 very schematically shows in the form of blocks an example of an electronic circuit 100 of the type to which the described embodiments apply.

Circuit 100 comprises a non-volatile memory 104 (FLASH MEMORY), for example of FLASH memory type, capable of communicating, via a communication bus 114, with a non-volatile memory interface 106 (FLASH INTERFACE) configured to write or read data into and from non-volatile memory 104. In an example, system programs and/or applications, such as boot programs, are implemented in memory 104.

Circuit 100 also comprises, for example, a processing unit 110 (CPU) comprising one or a plurality of processors under control of instructions stored in a system instruction memory 112 (INSTR MEM). Instruction memory 112 is for example a volatile random access memory (RAM). Processing unit 110 and memory 112 communicate, for example, via a system (data, address and control) bus 140. FLASH memory 104 is coupled to system bus 140 via non-volatile memory interface 106 and via bus 114. Device 100 further comprises an input/output interface 108 (I/O interface) coupled to system bus 140 to communicate with the outside.

Circuit 100 further comprises, for example, another memory 120 (USER MEM) of non-volatile type or of RAM type. This memory 120 is coupled to system bus 140 directly or via a memory interface (non-illustrated) having a role, for example, similar to that of interface 106.

Device 100 may integrate other circuits implementing other functions (for example, one or a plurality of volatile and/or non-volatile memories, other processing units), symbolized by a block 116 (FCT) in FIG. 1. Among these other circuits, circuit 100 for example comprises a read-only or static memory 118 (ROM).

One or a plurality of boot programs of the circuit are for example directly transferred to memory 104 during factory programming processes. The boot program(s) must not be modified once transferred to flash memory 104, unless circuit 100 is reset. For this purpose, it is provided to lock the access to the flash memory area containing the boot program, so that it cannot be accessed without a reboot. This is for example done by implementing a register (HDPL), for example monotonously increasing, having a value representative of the size of a forbidden access region of the memory containing the boot program(s), so that the boot program(s) cannot be accessed. For example, when the value of register HDPL is at 1, the boot program which is located in a region of the memory associated with value 1 can be executed. After execution, value HDPL is incremented to 2, which forbids the access to the boot program located in the memory region associated with value 2. If a second boot program has been loaded into the memory in sectors between HDPL1 and HDPL2, then it can be executed, after which value HDPL is incremented to 3, which forbids the access to the two boot programs located in the memory regions associated with value 1 and 2. Applications are then for example implemented in the memory without having the same access restriction level.

In certain architectures, such as for example those of ARM® v8M or ARM CORTEX® M33 type, by selecting an option during the development, the circuit resources or memories, but also certain programs, may be partitioned with different security levels. This mechanism is called “Trustzone” in these examples. A first security level (secure) is for example implemented by establishing that, when a non-secure transaction requires access to a secure resource of the microprocessor, then an error is for example returned over bus 140 and when a secure transaction requires access to a non-secure resource of the microprocessor, then an error is also returned. The rest of the circuit and/or of the programs is then for example implemented with less stringent security principles where for example programs having a security level lower than the first level can only access the non-secure resources and memories of circuit 100.

In certain architectures, such as for example those of ARM® CORTEX® M85 type, there are no options for choosing to partition or not the circuit resources, memories, and programs with different security levels. In these architectures, only the high security level is available. In other words, in these architectures, the “Trustzone” mechanism does not natively have the possibility of being disabled. There is thus basically an isolation (for example called TZIsolation) between resources, memories, or programs having the first security level and a less secure mode. This may raise issues to enable to easily develop applications which do not require implementing a safety isolation, such as for example the “Trustzone” mechanism, or which even simply do not need to be secured.

The described embodiments provide implementing a method of selecting boot programs, each contained in two separate storage memories of the microprocessor, where an option register read first at the resetting of said microprocessor conditions the selection of one of said boot programs.

This enables to for example avoid the systematic implementation of a system for partitioning the resources, memories, or programs between a plurality of security levels. It is thus possible to obtain a single security level or to generate a single security level for all the resources, memories, and programs used.

This further enables to obtain a software solution enabling to facilitate the development of applications which do not require a high security level. Such a mode is for example known as “legacy”.

Since there are no hardware modifications and no modifications to the code natively embedded in the circuit to implement the described embodiments, this introduces no additional vulnerabilities in terms of security.

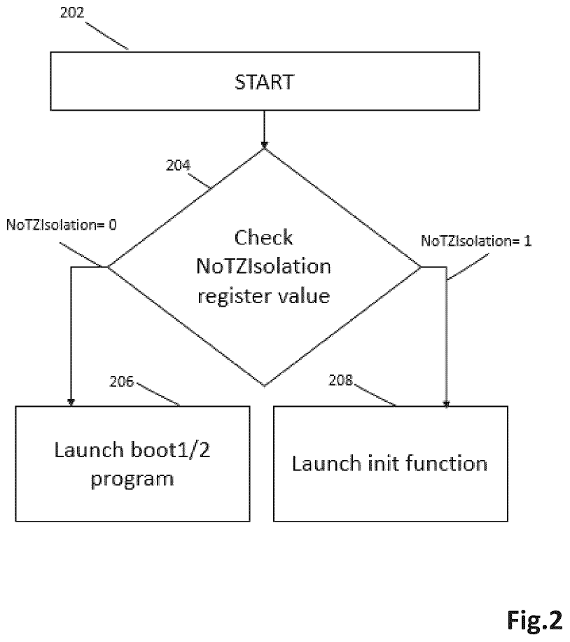

FIG. 2 illustrates an implementation mode of a method of selection of boot programs for the circuit of FIG. 1.

In a first step 202 (START), the method starts. This step for example corresponds to a resetting of circuit 100.

In a second step 204 (Check NoTZIsolation register value), a register NoTZIsolation is read from before the implementation of boot programs. For example, if the value of register NoTZIsolation=0, then a step 206 (Launch boot1/2 program) is implemented, and if, for example, NoTZIsolation=1, then a step 208 (Launch init function) is implemented.

At step 206, a boot program boot1 is implemented from a system memory of the circuit 100. The system memory is for example FLASH memory 104 or memory 112. This boot program boot1 enables, for example, to implement a partition between the circuit resources or memories, but also certain programs with different security levels, as is the case, for example, for the “Trustzone” mode of brand ARM®.

At step 208, another boot program, also called initialization function (init), is implemented from a user memory, which is for example memory 120.

In an example, initialization function init is configured to modify a value of register HDPL representative of the size of the forbidden access region of the system memory containing boot program boot1, so that boot program boot1, and possible other boot programs located immediately after in the system memory, cannot be accessed or executed until the implementation of boot program init. When only boot program boot1 is present in the system memory, the modification of the value of register HDPL by initialization function init comprises increasing the value HDPL by one bit, for example to pass from 1 to 2. Register HDPL for example being monotonously increasing, this enables boot program boot1 not to be implemented, as it can no longer be accessed. When there is, for example, a boot program boot2 in addition to boot program boot1 in the system memory, the modification of the value of register HDPL by initialization function init comprises increasing value HDPL by more than one bit. HDPL then for example passes from 1 to 3, which enables for none of boot programs boot1 and boot2 to be implemented, as they can no longer be accessed. Only initialization function init is implemented as a boot program, which enables to avoid the systematic implementation of a system of partition of the resources, memories, or programs between a plurality of security levels. Due to initialization function init, it is possible to obtain a single security level or to generate one and the same security level for all the resources, memories, and programs used by developed applications which use initialization function init.

In an example, boot program init, when it is selected, implements a configuration of the microprocessor so that it is in a secure mode where, when a non-secure transaction requires access to a secure resource of the microprocessor, then an error is returned over bus 140 for example.

In another example, when boot program init is selected, it implements a configuration of the microprocessor so that it is in a secure mode where, when a secure transaction requires access to a non-secure resource of the microprocessor, then an error is returned.

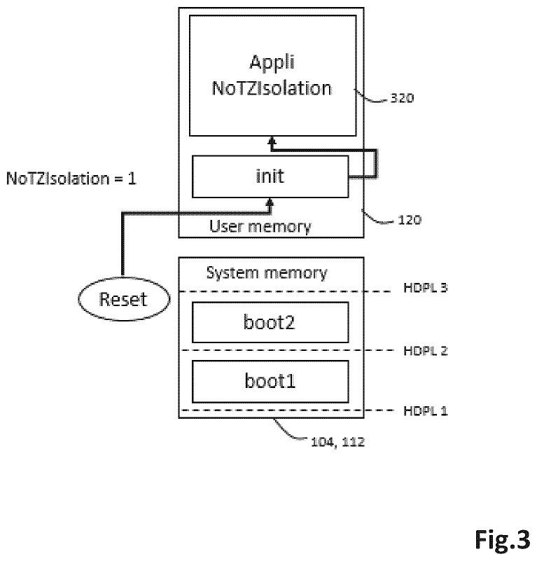

FIG. 3 illustrates another implementation mode of a method of selection of boot programs for the circuit of FIG. 1.

More specifically, the illustrated example describes the user memory, implemented for example by memory 120, and the system memory, implemented for example with one of memories 104 or 112.

In the shown example, two successive boot programs, boot1 and boot2 have been previously loaded into the system memory, and initialization function init is present in user memory 120 or loaded during a resetting of circuit 100.

At the resetting Reset of circuit 100, and as in the shown example, the read value of register NoTZIsolation is 1 (NoTZIsolation=1) and this, before programs boot1 and boot2 are implemented.

At resetting Reset, processing unit 110 will start by executing, and possibly previously loading, initialization function init, which is thus first implemented. This function changes the value of register HDPL from 1 to 3 to prevent the implementation, for example, the execution, of boot programs boot1 and boot2, which could have created a partitioning in terms of security levels of the resources, memories, and programs.

Initialization function init, for example, configures circuit 100 in a security mode where the resources, application memories, and programs have the same security level, that is, without a partitioning with a plurality of security levels.

One or a plurality of applications 320 (Appli NoTZIsolation) are then executed with the security level established by initialization function init.

In an example, initialization function init, when selected, enables to implement a debugging function authorized to access one or a plurality of the regions of user memory 120 and/or of system memory 104, 112. This debugging function may, for example, be limited to applications on memory sectors corresponding to a value of register HDPL greater than or equal to 2 if only boot1 is present, or greater than or equal to 3 if boot1 and boot2 are present, for example.

When, at the resetting Reset of circuit 100, the read value of register NoTZIsolation is 0 (NoTZIsolation=0), then programs boot1 and boot2 are implemented without for initialization function init to be implemented.

According to the value of register NoTZIsolation, different boot programs init, boot1/boot2 can thus be executed. A different security architecture can thus be provided according to this value read at resetting Reset.

The register NoTZIsolation is for example not present directly in the circuit or microcontroller 100. It is for example present in another circuit, for example a development or programming circuit board or a computer circuit, which is coupled, for example with a JTAG connection to the circuit or microcontroller 100.

The system memory is for example a part of or a whole memory, which is reserved for example to the manufacturer of the circuit or microcontroller 100. This system memory contains a bootloader and other security functions that only the manufacturer can access. This system memory is for example programmed during the manufacturing of the circuit or microcontroller 100. A user, which is for example an integrator or an OEM, cannot modify the system memory. The user memory is, on the other hand, a part or the whole memory reserved for the user and it will contain the user application firmware. In an example, the system memory and the user memory are regions of two different non-volatile memories. In another example, the system memory and the user memory are two regions of a same non-volatile memory, for example FLASH.

Various embodiments and variants have been described. Those skilled in the art will understand that certain features of these various embodiments and variants may be combined, and other variants will occur to those skilled in the art.

Finally, the practical implementation of the described embodiments and variants is within the abilities of those skilled in the art based on the functional indications given hereabove. In particular, regarding the user memory, it may be implemented by those skilled in the art, for example, in a dedicated region of memory 104 which is different from and isolated from the region dedicated to boot program boot1. Further, although the described examples mention the modification of register HDPL to implement initialization function init without for boot1 and/or boot2 to be implemented, those skilled in the art may implement any similar mechanism, enabling to prevent the implementation of boot programs boot1/boot2 after initialization function init has been started.

1. A method of a selection of a boot program of a plurality of boot programs, each contained in two separate storage memories of a microprocessor wherein an option register, read first during a resetting of the microprocessor, conditions the selection of one of the plurality of boot programs.

2. The method of claim 1, wherein a first boot program is contained in a user memory and a second boot program is contained in a system memory.

3. The method of claim 1, wherein at an initialization of a system comprising the microprocessor, when the option register has a first value, a first boot program is selected.

4. The method of claim 3, wherein at the initialization of the system, when the option register has a value other than the first value, a second boot program is selected.

5. The method of claim 3, wherein the first boot program, when it is selected, is configured to modify a value of a second register representative of a size of a forbidden access region of a system memory containing a second boot program so that the second boot program is not accessible.

6. The method of claim 5, wherein the first boot program, when it is selected, is configured to modify the value of the second register representative of the size of the forbidden access region of the system memory containing the second boot program and a third boot program so that the second and third boot programs are not accessible.

7. The method of claim 5, wherein the value of the second register can only be incremented.

8. The method of claim 6, wherein to modify the value of the second register includes an increase by more than one bit.

9. The method of claim 2, wherein at least one application is executable from user memory after the selection of the first boot program.

10. The method of claim 2, wherein the first boot program, when it is selected, implements a configuration of the microprocessor so that it is in a secure mode where, when a non-secure transaction requires access to a secure resource of the microprocessor, then an error is returned.

11. The method of claim 2, wherein the first boot program, when it is selected, implements a configuration of the microprocessor so that it is in a secure mode where, when a secure transaction requires access to a non-secure resource of the microprocessor, then an error is returned.

12. The of claim 6, wherein the first boot program, when it is selected, enables to implement a debugging function authorized to access one or a plurality of regions of the system memory corresponding to a value of the second register containing the second boot program and the third boot program.

13. The method of claim 2, wherein the user memory is a non-volatile memory or a RAM-type memory.

14. The method of claim 9, wherein a plurality of applications are executable from the user memory after use of the first boot program and wherein each of these applications is in a same security mode.

15. The method of claim 1, wherein the option register is external to the microprocessor.

16. The method of claim 15, wherein the option register is in a computer coupled to the microprocessor.

17. A microprocessor comprising a system memory and a user memory, wherein the microprocessor is configured to implement the method of claim 1.
